(19) United States
(12) Patent Application Publication
(10) Pub. No.: US 2010/0153506 A1
(43) Pub. Date: Jun. 17, 2010

(54) METHOD AND SYSTEM FOR LOGGING IN TO INSTANT MESSENGER

(75) Inventor: Jeong Kyu LIM, Gyeonggi-do (KR)

Correspondence Address: CHA & REITER, LLC, 210 ROUTE 4 EAST STE 103, PARAMUS, NJ, 07652, US

(73) Assignee: Samsung Electronics Co. LTD., Gyeonggi-Do (KR)

(21) Appl. No.: 12/636,904

(22) Filed: Dec. 14, 2009

(30) Foreign Application Priority Data
Dec. 17, 2008 (KR) 10-2008-0128251

(51) Int. Cl. G06F 15/16

(52) U.S. Cl. 709/206

(57) ABSTRACT

A method and system logging in to an Instant Messenger (IM) a includes: registering login schedule information to an IM server; transmitting, by the IM server, login information to an IM client when a login time included in the login schedule information arrives; and logging in, by the IM client, to the IM server using the login information. A user of the mobile terminal presets the login schedule information so that the mobile terminal may login automatically to an IM community at a preset time. If the user of the mobile terminal forgets to log in at the preset time, the mobile terminal may log in to the IM community automatically.

### CLAIM OF PRIORITY

This application claims the benefit of priority from an application entitled “METHOD AND SYSTEM FOR LOGGING IN TO INSTANT MESSENGER” filed in the Korean Intellectual Property Office on Dec. 17, 2008 and assigned Serial No. 10-2008-0128251, the contents of which are incorporated herein by reference in its entirety.

### BACKGROUND OF THE INVENTION

1. Field of the Invention

The present invention relates generally to a method and a system for logging in to an instant messenger communication application. More particularly, the present invention relates to a method and a system for improving access to an instant messenger so that messages are not missed due to the user being logged off.

2. Description of the Related Art

With recent rapid and widespread adoption of wireless communication and the increasing need for people and objects to be accessible twenty four hours per day, mobile terminals have become a modern necessity. Mobile terminals provide various data transmission services and various supplementary services in addition to the mobile terminal's own voice communication services, such that mobile terminals have changed into multimedia communication devices in view of their increased functionality. As the data transfer rate increases, the mobile terminal may function as an instant messenger (hereafter, IM), which is currently possible only in an existing personal computer (PC).

In order to use the IM in the mobile terminal, a mobile terminal user must access an IM server to log in to an IM community. That is, when the mobile terminal user desires to use the IM service, the mobile terminal user manually inputs the login information to log in to the IM community. Due to security reason, a log in for instant messenger is not perpetual, and it is common that no more than a certain predetermined time be set as a maximum (e.g. 24 hours) before the user will be logged off and have to re-enter their sign-on and password. In order to ensure there is no lapse to being logged on to an instant messenger, the mobile terminal user may need to log in to the IM community at a preset time in daily life or business. For example, the mobile terminal user may enter an appointment in their electronic scheduler or calendar to log in to the IM community at a preset time in order to receive an important message or file from a friend and may periodically hold a conference using the IM service. In such a case, when the mobile terminal user forgets to log in to the IM community or does not log in to the IM community due to unavoidable circumstances, the mobile terminal user may not receive the message or the file and may not attend the conference through the IM service. When login to the IM community is automatically performed at a preset time, the mobile terminal user may receive the message or the file and may check the content in the conference without having to attend the conference.

Therefore, there is a need to provide a method of automatically logging in to the IM service at a desired time.

### SUMMARY OF THE INVENTION

The present invention has been made at least in part in view of the above problems, and the present invention provides a method of automatically logging in to an instant messenger service at a desired time.

The present invention also provides an instant messenger system that uses the above method.

In accordance with an exemplary embodiment of the present invention, a method of logging in to Instant Messenger (IM), preferably includes: registering login schedule information to an IM server; transmitting, by the IM server, login information to an IM client, when a login time included in the login schedule information arrives; and performing login, by the IM client, to the IM server using the login information.

In accordance with another exemplary embodiment of the present invention, the present invention also provides an Instant Messenger (IM) system that preferably includes: an IM client setting login schedule information and transmitting the set login schedule information to an IM server; and an IM server storing the login schedule information received from the IM client and transmitting login information to an IM client when a login time set in the stored login schedule information arrives.

According to the exemplary aspects of the present invention, a mobile terminal user sets login schedule information beforehand so to automatically log in to an instant messenger community at a preset time. Therefore, although the user forgets to log in to the IM community at the preset time, the mobile terminal may automatically log the mobile terminal user in to the IM community. In addition, by setting automatic login schedule information in an IM server, the user need not reset the automatic login schedule information although the mobile terminal is replaced or is reset. Therefore, the mobile terminal may continuously and automatically log in to the IM community at the preset time.

### BRIEF DESCRIPTION OF THE DRAWINGS

The exemplary features and advantages of the present invention will become more apparent from the following detailed description in conjunction with the accompanying drawings, in which:

FIG. 1 illustrates configuration of an instant messenger (IM) system according to an exemplary embodiment of the present invention;

FIG. 2A illustrates a configuration of a mobile terminal employed in the exemplary embodiment of the present invention;

FIG. 2B illustrates configuration of an IM server employed in the exemplary embodiment of the present invention;

FIG. 3 is a sequence diagram illustrating a method of logging in to an instant messenger according to an exemplary embodiment of the present invention;

FIG. 4A illustrates an example of a login schedule information setting menu used in an exemplary embodiment of the present invention;

FIG. 4B illustrates another example of a login schedule information setting menu used in an exemplary embodiment of the present invention;

FIG. 5A illustrates an example of a screen displayed on a display unit when the login schedule is performed on an idle screen of the mobile terminal; and

FIG. 5B illustrates another example of a screen displayed on the display unit when the login schedule is performed on an idle screen of the mobile terminal.

### DETAILED DESCRIPTION

Throughout the description of the present invention, the term “instant messenger (IM) community” refers to an instant messenger service provider, including but not in any way limited to, for example, ‘AIM’, ‘ICQ’, ‘Windows Live’, ‘Yahoo’, just to name a few possible non-limiting examples. Each of the IM communities includes an IM server and an IM client. The IM clients may be provided with IM services by the IM servers.

The term ‘login schedule information’ refers to schedule information set by the IM client and may include information on whether a scheduled login function is executed, a login time, a login cycle, and a device for performing the login function.

The term ‘login information’ refers to a login notification message that the IM server transmits to the IM client when a scheduled time arrives and that is included information required for the IM client to log in to the IM server. The login information may include, for example, user identification information (user ID), device identification information (Mobile Station International ISDN Number; MSISDN), and authentication information. In certain exemplary embodiment(s) of the present invention, when a client-server protocol (CSP) gateway serves as a relay between the IM client and the IM server, the IM server may transmit the user ID, the MSISDN, and the authentication information to the CSP gateway, so that the CSP gateway may determine an IM client to receive the login notification message using the MSISDN among the received information and transmit the user ID and the authentication information to the determined IM client using a short message service (SMS).

Hereinafter, exemplary embodiments of the present invention are described in detail with reference to the accompanying drawings. The same reference symbols are used throughout the drawings to refer to the same or like parts. Detailed descriptions of well-known functions and structures incorporated herein may be omitted to avoid obscuring appreciation of the subject matter of the present invention by a person of ordinary skill in the art.

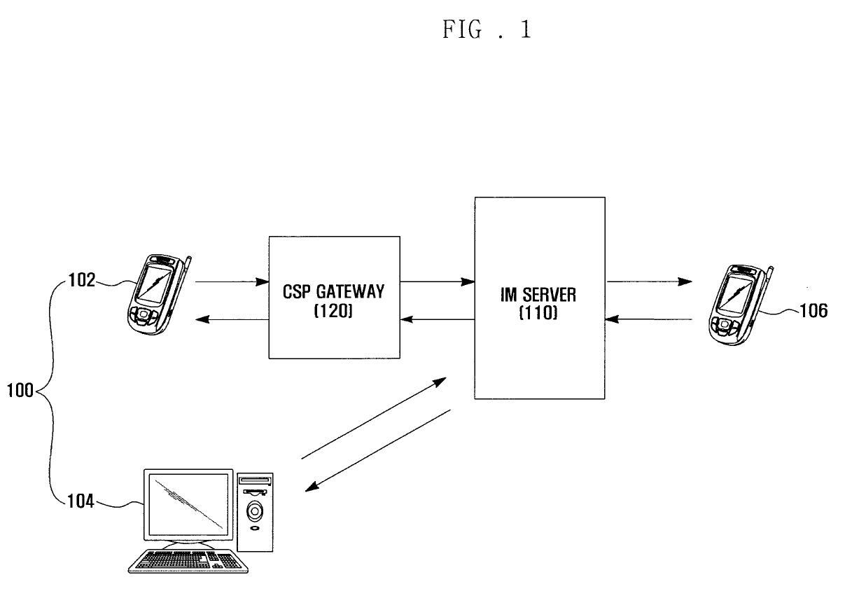

FIG. 1 illustrates an example of a configuration of an IM system according to an exemplary embodiment of the present invention.

The IM system according to the exemplary embodiment of the present invention preferably includes an IM client 100 and an IM server 110. The IM system may further include, for example, a client-server protocol (CSP) gateway 120.

The IM client 100 is provided with an IM service by the IM server 110. In FIG. 1, a mobile terminal A 102, a personal computer (PC) 104, and a mobile terminal B 106 all correspond to an IM client 100. The mobile terminal A 102 sets login schedule information and the mobile terminal B 106 transmits an instant message to the mobile terminal A 102 and receives the instant message from the mobile terminal A 102. The mobile terminals A (102) and B (106) are communication terminals performing wireless communications such as mobile communication terminals for code division multiple access (CDMA) and global system for mobile communication (GSM), personal digital assistants (PDA), smart phones, international mobile telecommunication (IMT)-2000 terminals, wideband code division multiple access (WCDMA) terminals, and universal mobile telecommunication service (UMTS) terminals.

The PC 104 accesses the IM server 110 through a wired or wireless network to receive the IM service. In the exemplary embodiment of the present invention, the mobile terminal 102 may set login schedule information such that the PC 104 performs login to the IM server 110. By setting the login schedule information, when the scheduled time arrives, the IM server 110 transmits the login information to the PC 104 and the PC 104 logs in to the IM server 110 according to the received login schedule information.

The IM server 110 provides the IM service. Every IM community includes IM servers. The IM servers transmit and receive messages between the IM clients 100 that subscribe to the IM communities. When the IM server 110 employed in the IM system of the present invention receives the login schedule information set by the IM client 100, the IM server 110 preferably stores the received login schedule information, determines whether a scheduled login time of the stored login schedule information arrives, and transmits the login information for the IM client 100 to log in to the IM server 110 to the IM client 100 when the scheduled login time arrives.

The CSP gateway 120 corresponds to a provider server that functions as a relay between the IM client 100 and the IM server 110. For example, the CSP gateway 120 may correspond to a server managed by a mobile communication service provider. In such a case, the mobile communication service provider accesses the IM server 110 not directly but via the CSP gateway 120 to calculate a data usage fee. The CSP gateway 120 transmits the login information to the IM client 100 using the SMS. The user ID and the authentication information may be included in the transmitted login information. The CSP gateway 120 may include a base station processing a call signal or an SMS message in a wireless network and a mobile switching center (MSC) controlling the transmission and reception of the call signal and the SMS message processed by the base station.

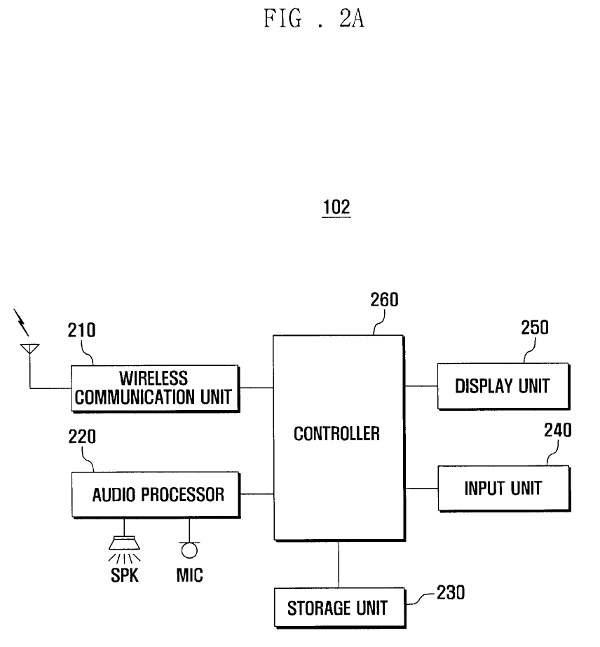

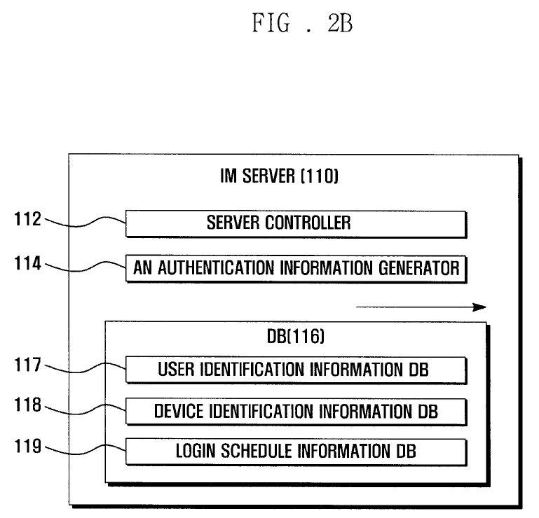

FIG. 2A is a block diagram illustrating the mobile terminal A 102 employed in the exemplary embodiment of the present invention.

As illustrated in FIG. 2, the mobile terminal 102 preferably includes a wireless communication unit 210 performing wireless communication, an audio processor 220 processing audio signals, a storage unit 230 storing programs and data, an input unit 240 through which commands for controlling the mobile terminal A 102 are input, a display unit 250 displaying various types of information, and a controller 260 controlling overall operation of the mobile terminal A 100. It is within the spirit and scope of the invention that the display may have a touchscreen and function as an input unit.

The wireless communication unit 210 performs the wireless communication of the mobile terminal. The wireless communication unit 210 may include an RF transmitter performing up-conversion of and amplifying the frequency of a transmitted signal and an RF receiver low-noise amplifying and down-converting frequency of a received signal. The wireless communication unit 210 may receive data through a wireless channel to output the received data to a controller 260 and may transmit the data output from the controller 260 through the wireless channel. The wireless communication unit 210 enables data communication between the mobile terminal 102 (shown in FIG. 1) and the IM server 110 through an information communication network (an internet network using TCP/IP protocol for wired access and a WAP protocol for wireless access).

More particularly, the wireless communication unit 210 transmits the login schedule information to the IM server 110 through the CSP gateway 120 under the control of the controller 260. In addition, the wireless communication unit 210 receives the login notification message from the IM server 110 and transmits a login request signal to the IM server 110 using the login information included in the received login notification message.

An audio processor 220 may constitute, for example, a codec. The codec includes a data codec processing packet data and an audio codec processing an audio signal such as voice. Using the audio codec, the audio processor 220 converts a digital audio signal into an analog audio signal to reproduce the converted analog signal and converts the analog audio signal generated and transmitted by a microphone into a digital audio signal. In this exemplary embodiment of the present invention, when the mobile terminal 102 sets the login schedule information and transmits the set login schedule information to the IM server 110, the IM server 110 stores the login schedule information and transmits a response to the transmission of the login schedule information to the mobile terminal 102. In this case, when the mobile terminal 102 receives the response to the transmission of the login schedule information, the audio processor 220 may output a sound effect corresponding to the received response to alert the user that the IM server has acknowledged receipt of the logins schedule information. When the scheduled login time arrives, the IM server 110 transmits the login notification message to the mobile terminal 102. When the mobile terminal 102 receives the login notification message, the audio processor 220 may output the sound effect corresponding to the received login notification message. The sound effect for each of the aforementioned functions could be the same or different, according to user preference. A person of ordinary skill in the art also understands and appreciates that a vibration and/or a flashing of the screen (of a display of the response) can be performed instead of or in addition to the sound effect.

With continued reference to FIG. 2A, storage unit 230 stores content and user data generated by a user as well as programs by executing the functions of the mobile terminal. The storage 230 stores the login schedule information set by the mobile terminal 102. The login schedule information may include, for example, the information on the login time, the login cycle, whether the scheduled login function is executed, and the device for performing login. When the mobile terminal 102 sets the login schedule information, the set login schedule information is transmitted to the IM server 110. Not only does the IM server 110 store the received login schedule information, but also the mobile terminal 102 stores the set login schedule information in the storage 230 of the mobile terminal 102 to enable the user of the mobile terminal 102 in order to confirm the set login schedule.

The input unit 240 receives the user manipulation signal for controlling the mobile terminal 102 and transmits the received manipulation signal to the controller 260. The input unit 240 may include a keypad or a touch pad and may include alphanumeric keys for inputting number and character information items and function keys for setting various functions. In the exemplary embodiment of the present invention, the user may set the login schedule information through the input unit 240.

The display unit 250 may comprise a liquid crystal display (LCD) and visually provides a menu of the mobile terminal, user input data input by the user, and function setting information and various other information to the user. A person of ordinary skill in the art should understand and appreciate that any type of display screen, for example, such as a thin-film or flexible display can also be used. The display unit 250 outputs a boot screen, an idle screen, a display screen, a call screen, and various other application execution screens of the mobile terminal 102. The display 250 displays an IM service execution screen. Information on user status, online subscribers, and offline subscribers is displayed on the IM service execution screen. The display unit 250 displays a menu for setting the login schedule information. The login schedule information setting menu may include a menu for setting the information on a login time, a login cycle, whether a scheduled login function is executed, and a device performing login.

The controller 260 controls overall operation of the mobile terminal. The controller 260 controls the display unit 250 to display a login schedule information menu when a command of setting login schedule information is input. The login schedule information menu may include a menu for selecting the login time, the login cycle, whether the scheduled login function is executed, and the device performing login. When the login schedule information is set, the controller 260 preferably controls the storage of the set login schedule information in the storage unit 230. The controller 260 controls the wireless communication unit 210 to transmit the set login schedule information to the IM server 110. The controller 260 may transmit the login schedule information to the CSP gateway 120 and may control the CSP gateway 120 to transmit the received login schedule information to the IM server 110. The controller 260 controls the wireless communication unit 210 to receive the login notification message from the IM server 110. The controller 260 performs login to the IM server 110 using the login information included in the login notification message received through the wireless communication unit 210.

FIG. 2B illustrates a preferable configuration of the IM server 110 employed in the exemplary embodiment of the present invention.

The IM server 110 preferably includes a server controller 112, an authentication information generator 114, and a database 116 (or access to a database).

The server controller 112 controls overall functions of transmitting and receiving a message between IM clients 100 (such as mobile terminals 102 and 104 shown in FIG. 1). The server controller 112 stores the login schedule information received from the IM client 100 in a login schedule information database 119. The server controller 112 determines whether the scheduled login time arrives and transmits the login information to a target IM client 100 of the scheduled login when the scheduled login time arrives. The login information may include the user identification information, the device identification information, and the authentication information. The server controller 112 extracts the user identification information from a user identification information database and the device identification information from a device identification information database and transmits the extracted user and device identification information to the IM client 100. The authentication information is generated by the authentication information generator 114 and the server controller 112 transmits the generated authentication information to the IM client 100.

The authentication information generator 114 generates the authentication information required when the IM client 100 logs in to the IM server 110. In this exemplary embodiment, a login token may be used as the authentication information and the authentication information generator 114 generates the login token using a session ID indicating a session validation.

The database 116 preferably includes a user identification information database 117, a device identification information database 118, and a login schedule information database 119. The user identification information database 117 preferably includes information on the user ID of an IM service subscriber and the device identification information database 118 preferably includes identification information for identifying the IM client. In this exemplary embodiment, information on MSISDN corresponding to the telephone number of the IM clients is stored in the device identification database 118. The login schedule information set by the IM clients is stored in the login schedule information database 119. The login schedule information may include information on the login time, the login cycle, whether the scheduled login function is executed, and a device performing the login.

Hereinafter, an exemplary method of logging in to the IM will be described.

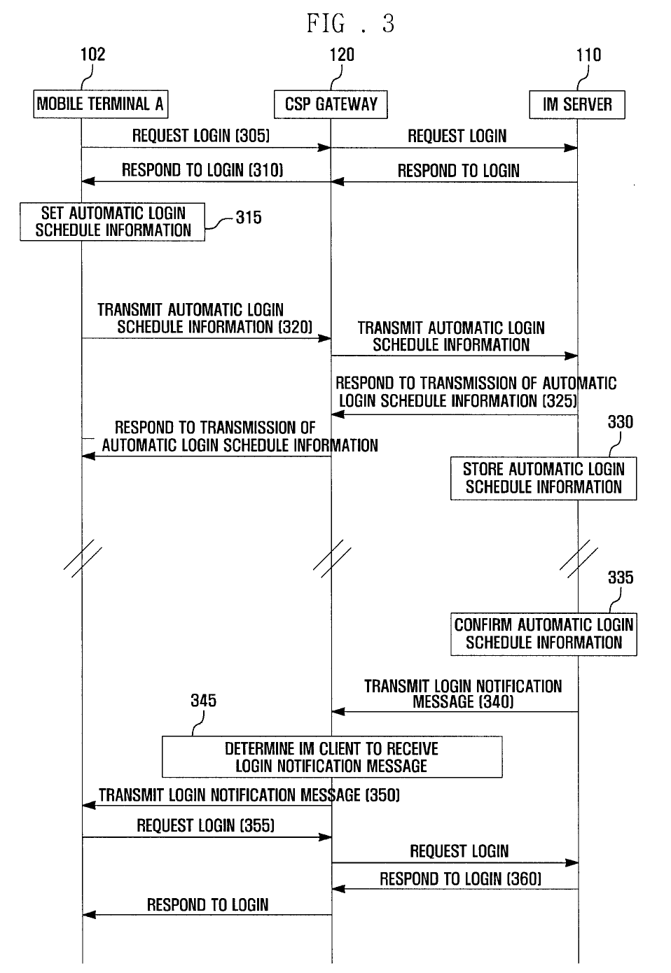

FIG. 3 illustrates an operational illustration of a method of logging in to the IM according to an exemplary embodiment of the present invention.

Now referring to FIG. 3, the mobile terminal A (shown in FIG. 1 and identified as 102 but referred to herein as “A”) transmits the login request signal to the IM server 110 through the CSP gateway 120 (step 305). The IM server 110 transmits a login response signal to the login request signal to the mobile terminal A (step 310) and the mobile terminal A completes the login to the IM server 110 performed by the mobile terminal A. A detailed login process will be described, hereinafter, focused on the mobile terminal 102 and the IM server 110.

The user of the mobile terminal A 102 inputs user identification information (user ID) and a password, and the mobile terminal A transmits the login request signal including the information input by the user to the IM server 110. The IM server 110 transmits the login response signal as a response to the login request signal to the mobile terminal A. By doing so, the mobile terminal A is authenticated on whether the login is allowed by the IM server 110.

Then, the mobile terminal A transmits information on the mobile terminal (ClientCapbility-Request) to the IM server 110. Information on the mobile terminal includes device information and information on a message transmission method. The IM server 110 receives the information on the mobile terminal and transmits the response (ClientCapbility-Response) to the information on the mobile terminal to the mobile terminal A. The mobile terminal A requests the service desired by the user from the IM server 110 (Service-Request). The service desired by the user includes a messenger service, a presence service representing the user status information, etc., as possible non-limiting examples. The IM server 110 confirms the service desired by the user and transmits the response to the service to the mobile terminal A (Service-Response).

The mobile terminal A requests the list of registered IDs (GetList-Request). The list of the registered IDs may include the list of online IDs and the list of offline IDs. The IM server 110 transmits the list of the registered IDs to the mobile terminal A (GetList-Response). Then, the mobile terminal A requests information on the ID list, such as the nicknames of the IDs to the IM server 110 (ListManage-Request). The IM server 110 transmits information on the ID list to the mobile terminal A as a response (GetManage-Response). The mobile terminal A 102 requests information on a blocked ID in the ID list from the IM server 110 (GetblockList_Request). The IM server 110 transmits the information on the blocked IDs to the mobile terminal A (GetblockList-Response). When the portable terminal A needs to change the user presence state information, the mobile terminal A requests the IM server 110 to update the user presence state information (subscribePresence-Request).

According to the aforementioned exemplary embodiment of the present invention, login is executed by performing the above mentioned series of processes. When the processes are completed, the login processes of the portable terminal A to the IM server 110 are completed.

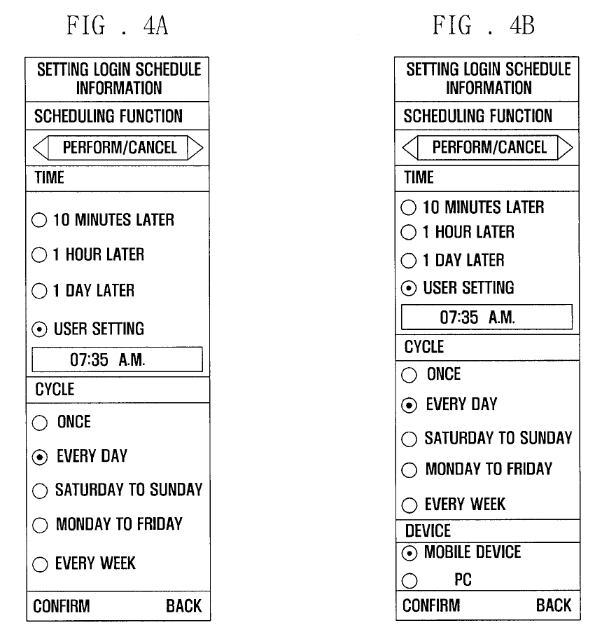

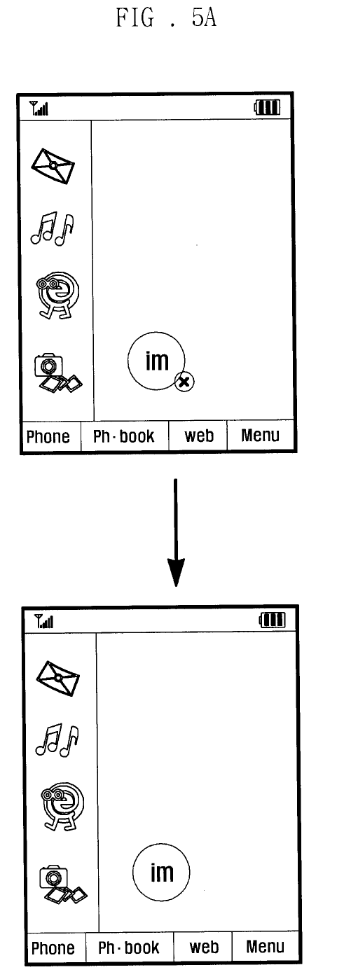

The user of the mobile terminal A sets the login schedule information in the state wherein the mobile terminal A is logged in to the IM server 110 (step 315). A login schedule information setting menu may correspond to the setting menu included in an IM community being logged in to currently and may correspond to a setting menu basically included in the mobile terminal A. The user of the mobile terminal A selects the login schedule information setting menu to set the login schedule information. An automatic login schedule information setting menu is illustrated in FIGS. 4A and 4B in detail.

FIG. 4A illustrates a login schedule information setting menu employed in an exemplary embodiment of the present invention. FIG. 4A illustrates a menu for selecting whether to execute a scheduled login, a login time setting menu, a login cycle setting menu, a menu for completing the setting of the login schedule information, and a menu for returning to a previous process. The user may set whether to execute the scheduled login at a scheduled time through the menu for selecting whether to execute the scheduled login function. The user may set the login time so that the mobile terminal A 102 automatically logs in at the set scheduled time. The login time may be set by minute, hour, and day and set optionally through a user setting menu. The user of the mobile terminal A 102 may set a cycle executing the scheduled login through the login cycle setting menu. The login cycle may be set to ‘once’, weekend, Monday to Friday, every week, every day, and so forth. When the user of the mobile terminal A sets the login time, the login cycle, and instructions regarding whether to execute the scheduled login function and then selects a ‘Complete’ button, the setting of the login schedule information is completed. On the other hand, when the user selects a “Back” button, the menu setting the login schedule information is returned to the previous process.

FIG. 4B illustrates the menu for setting the login schedule information employed in another exemplary embodiment of the present invention. FIG. 4B illustrates the menu for selecting whether to execute a scheduled login function, a login time setting menu, a login cycle setting menu, and a menu for completing the setting of the login schedule information, and a menu for returning to a previous process, as in the description of FIG. 4A. In addition, FIG. 4B illustrates a menu for selecting a device to perform the scheduled login function. In another exemplary embodiment of the present invention, the scheduled login function may be performed automatically by the IM client 100 in addition to the mobile terminal A by setting the login schedule in the mobile terminal A. For example, when the IM client 100 is the mobile terminal A or comprises a personal computer (PC), the user of the mobile terminal A may select one of the mobile terminal A and the PC 104 (shown in FIG. 1) as the device for performing the scheduled login to the IM server 110. When the user of the mobile terminal A sets the PC 104 to automatically log in to the IM server 110, the user may set information on both Internet Protocol (IP) information and port of the PC 104 in the login schedule information setting menu.

When the user of the mobile terminal A 102 sets the login schedule information and presses the ‘Complete’ key, the mobile terminal A transmits the login schedule information to the IM server 110 through the CSP gateway 120 (step 320). The mobile terminal A transmits the login schedule information (information on the login time, the login cycle, whether the scheduled login function is executed, and the device performing the login) set by the mobile terminal A and the device identification information (Device-Identifier) to the IM server 110. The mobile station international ISDN number (MSISDN) may be used as the identification information of the mobile terminal A and the MSISDN, in the present invention, refers to the telephone number of the mobile terminal A. The IM server 110 transmits a response to the reception of the login schedule information from the mobile terminal A to the mobile terminal A via the CSP gateway 120 (step 325). Then, the IM server 110 stores the login schedule information (step 330).

The IM server 110 determines whether the login time set in the login schedule information arrives in real time. The IM server 110 stores a list of IM clients performing automatic login by time. The IM server 110 confirms whether the login time set by the mobile terminal A arrives (step 335). The IM server transmits the login notification message to the CSP gateway 120 (step 340). The login notification message includes the login information. The login information used in this exemplary embodiment may include the user identification information, the device identification information, and the authentication information. A User ID may be used as the user identification information and MSISDN indicating the telephone number of the mobile terminal A may be used as the device identification information. A Login token may be used as the authentication information.

The login token refers to an arbitrary constant, which the IM server 110 provides to an IM client to perform the scheduled login to authenticate the scheduled login, and substitutes for a function of the password (step 305). When the login is not performed successfully in a valid time due to network problems, the login token is used to stop the login. The login token is generated by using a session ID, wherein the session ID indicates a value used to authenticate the session validation. The mobile terminal A performs the login using the login token provided by the IM server 110 through the login notification message.

When the CSP gateway 120 receives the login notification message, the CSP gateway 120 determines the IM client to receive the login notification message using the device identification information in the login information included in the login notification message (step 345). When the CSP gateway 120 determines that the IM client to receive the login notification message corresponds to the mobile terminal A (step 345), the CSP gateway 120 transmits the login notification message to the mobile terminal A (step 350). The CSP gateway 120 may transmit the login notification message to the mobile terminal A using a short message service (SMS). The login notification message includes the login information and the login information includes the user identification information (User ID) and the authentication information (Login-Token).

The mobile terminal A requests the IM server 110 to allow the login using the user identification information (User ID) and the authentication information (Login-Request) (355). Although the mobile terminal A 102 requests the IM server 110 to allow the login by inputting the user identification information (User ID) and the password in a general login request step, in this exemplary embodiment the mobile terminal A logs in using the user identification and the authentication information (the login token) (step 355). The IM server 110 transmits a response to the login request of the mobile terminal A 102 to the mobile terminal A through the CSP gateway 120 (step 360). The mobile terminal A transmits the mobile terminal information such as the device information and the message transmitting method to the IM server 110 and receives user presence state information (presence), registered ID list information, ID list information corresponding to the nickname of each ID, and blocked ID information to complete the login process.

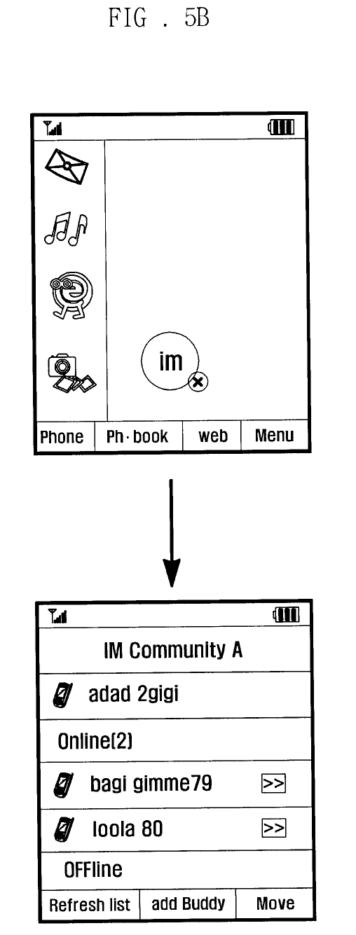

FIG. 5A and FIG. 5B illustrate a screen displayed on the display unit of the mobile terminal A in the login execution process.

FIG. 5A illustrates a screen displayed on the display unit when performing the scheduled login at the idle screen of the mobile terminal A 102. The screen of the mobile terminal A displays an icon indicating the instant messenger (icon IM). The screen displays a present state of the mobile terminal A, that is, offline, and a mark indicating that the user is offline (mark of “x”). When the scheduled login time arrives, the mobile terminal A 102 receives the login notification message from the IM server 110 and performs the scheduled login to IM server 110 using the user identification information and the authentication information in the login information included in the login notification message. The IM icon is changed to a mark indicating being logged in to the IM community currently (the mark x disappears).

FIG. 5B illustrates another example of a screen displayed on the display unit in performing the scheduled login at the idle screen of the mobile terminal A 102.

The screen of the mobile terminal A displays the icon indicating the instant messenger (IM icon) similarly as in FIG. 5A and displays the mark “x” indicating the current state is logged out. The mobile terminal A performs the scheduled login to IM server 110 using the user identification information and the authentication information included in the login information received from the IM server 110 and displays an IM community menu screen based on the received information from the IM server 110. A user ID (adad2gjgj), user status information (an icon to the left of the user ID), and subscriber IDs that are currently online (bagi gimme79 and loola80) are displayed at the IM community menu screen. In addition, the subscribers that are offline and the other function icons may be displayed at the IM community menu screen. The mobile terminal A performs the scheduled login and displays the IM community menu screen so that the user of the mobile terminal A may use the IM service directly.

The above-described methods according to the present invention can be realized in hardware or as software or computer code that can be stored in a recording medium such as a CD ROM, an RAM, a floppy disk, a hard disk, or a magneto-optical disk or downloaded over a network, so that the methods described herein can be rendered in such software using a special processor or in programmable or dedicated hardware, such as an ASIC or FPGA. As would be understood in the art, the computer, the processor or the programmable hardware include memory components, e.g., RAM, ROM, Flash, etc. that may store or receive software or computer code that when accessed and executed by the computer, processor or hardware implement the processing methods described herein.

Although exemplary embodiments of the present invention have been described in detail hereinabove, it should be understood that many variations and modifications of the basic inventive concept as described herein, which may appear to those skilled in the art, will still fall within the spirit and scope of the exemplary embodiments of the present invention as defined in the appended claims.

What is claimed is:

1. A method of logging in to an Instant Messenger (IM) communication service, comprising:
registering login schedule information by an IM server;
transmitting, by the IM server, login information to an IM client, when a login time included in the login schedule information for said IM client arrives; and
receiving by the IM server a login request signal and logging the IM client onto the IM service.

2. The method of claim 1, wherein registering the login schedule information comprises:
receiving by the IM server, the login schedule information set by said IM client; and
storing by the IM server, the transmitted login schedule information.

3. The method of claim 1, wherein the login schedule information comprises information identifying the login time.

4. The method of claim 3, wherein the login schedule information further comprises at least one of information on a login cycle, whether a scheduled login is executed, and an identification of a device requesting a login to the IM service.

5. The method of claim 2, wherein setting and transmitting the login schedule information further comprises:
receiving by the IM server, device identification information of the IM client.

6. The method of claim 1, wherein the login information comprises user identification information and authentication information.

7. The method of claim 6, wherein IM server communicates with the mobile terminal via a client-server protocol (CSP) Gateway.

8. The method of claim 1, wherein the IM server provides a token to the IM client to perform the scheduled login to authenticate the scheduled login.

9. The method according to claim 1, wherein said IM client comprises a mobile terminal, and the IM server receives information that a personal computer (PC) is set by the mobile terminal to perform a login, and wherein the IM server receives information regarding at least both Internet Protocol (IP) information and a port of the PC in the login schedule information.

10. An Instant Messenger (IM) system, comprising:
an IM server receiving a login schedule information set by an IM client and storing the login schedule information received from the IM client and transmitting login information to an IM client when a login time set in the stored login schedule information arrives.

11. The Instant Messenger (IM) system of claim 10, wherein the IM server receives device identification information of the IM client.

12. The Instant Messenger (IM) system of claim 10, wherein the IM server receives a login request from the IM client using the login information transmitted by the IM server.

13. The Instant Messenger (IM) system of claim 10, wherein the login schedule information comprises information on the login time.

14. The Instant Messenger (IM) system of claim 13, wherein the login schedule information further comprises at least one of information on a login cycle, whether a schedule login is executed, and a device performing the login.

15. The Instant Messenger (IM) system of claim 10, wherein login information comprises user identification information and authentication information.

16. The Instant Messenger (IM) system of claim 15, wherein the IM server communicates with the mobile terminal via a client-server protocol (CSP) Gateway.

17. The Instant Messenger (IM) system of claim 11, wherein the IM server provides a token to the IM client to perform a scheduled login to authenticate the scheduled login.

18. The Instant Messenger (IM) system of claim 11, wherein said IM client comprises a mobile terminal, and the IM server receives information that a personal computer (PC) is set by the mobile terminal to perform a login, and wherein the IM server receives information regarding at least both Internet Protocol (IP) information and a port of the PC in the login schedule information.
